(19) United States
(12) Patent Application Publication
(10) Pub. No.: US 2021/0187567 A1
(43) Pub. Date: Jun. 24, 2021

(54) Pipe Cleaning Device

(71) Applicant: Maurice Watson, Clinton, MD (US)

(72) Inventor: Maurice Watson, Clinton, MD (US)

(21) Appl. No.: 17/113,174

(22) Filed: Dec. 7, 2020

Related U.S. Application Data
(60) Provisional application No. 62/949,587, filed on Dec. 18, 2019.

(51) Int. Cl. B08B 9/02; A46B 9/02; A46B 13/00; A46B 13/02

(52) U.S. Cl. CPC B08B 9/021; A46B 9/025; A46B 9/026; A46B 2200/3093; A46B 13/02; A46B 2200/3013; A46B 13/001

(57) ABSTRACT

A pipe cleaning device is shown and described. The pipe cleaning device includes a handle member which has an interior volume. The handle member is attached to a head member. The head member has an aperture located through the middle thereof. The aperture is lined with a movable wire brush which rotates around the interior of the aperture. The head member further contains a brush motor. The brush motor circulates the brush around the interior of the aperture.

### CROSS REFERENCE TO RELATED APPLICATIONS

This application claims the benefit of U.S. Provisional Application No. 62/949,587 filed on Dec. 18, 2019. The above identified patent application is herein incorporated by reference in its entirety to provide continuity of disclosure.

### BACKGROUND OF THE INVENTION

The present invention relates to metal pipe cleaning. More particularly, the present invention provides a hand-held device that will clean metal piping.

There are many different jobs that will require individuals to have to clean metal piping. Metal piping traditionally needs cleaned before it is fastened together. In particular copper piping needs cleaned before it is soldered together.

Copper piping is currently cleaned by hand. This involved taking a wire brush or sandpaper and brushing the entire exterior of the pipe. This requires that the pipe be constantly rotated in order to ensure every surface is cleaned. This process can be extremely time consuming. Further, after cleaning piping for an extended period of time one may experience hand cramps of other physical pain such as carpal tunnel may result.

Consequently, there is a need for an improvement in the art of cleaning metal piping. The present invention substantially diverges in design elements from the known art while at the same time solves a problem many people face when having to clean a large number of linear feet of metal piping. In this regard the present invention substantially fulfills these needs.

### SUMMARY OF THE INVENTION

The present invention provides a pipe cleaning device wherein the same can be utilized for providing convenience for the user when having to clean the exterior of metal piping. The pipe cleaning device comprises a handle member having an interior volume. The handle member is attached to a head member. The head member has an aperture located through a middle thereof, wherein the aperture is lined with a movable wire brush. The head member further contains a brush motor, wherein the brush motor circulates the brush around the interior of the aperture.

Another object of the pipe cleaning device is to provide a power source located within the handle member.

Another object of the pipe cleaning device is to provide a switch located on the handle member, wherein the switch operably couple to the brush motor.

Another object of the pipe cleaning device is to provide a handle member with an ergonomic grip.

Another object of the pipe cleaning device is to provide multiple rows of wire brushes located within the aperture of the head member.

Another object of the pipe cleaning device is to provide a head member containing a movable lever, wherein the movable lever contracts and expands the wire brush.

Another object of the pipe cleaning device is to provide a brush that expands to have a two-inch diameter.

Another object of the pipe cleaning device is to provide a brush that contracts to have a diameter of one-half inch.

Another object of the pipe cleaning device is to provide a removably attached removable head member instead of a fixed member.

Another object of the pipe cleaning device is to provide electrical contacts located on a base of the removable head member.

Another object of the pipe cleaning device is to provide electrical contacts located on a top side of the handle member.

Another object of the pipe cleaning device is to provide a collar located about the top of the handle member, wherein the collar secures to the removable head member.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the pipe cleaning device.

FIG. 2 shows a perspective view of an alternative embodiment of the pipe cleaning device.

FIG. 3 shows an exploded view of an alternative embodiment of the pipe cleaning device.

FIG. 4A shows a flow chart of an embodiment of the wiring for the pipe cleaning device

FIG. 4B shows a flow chart of an embodiment of the wiring for the pipe cleaning device.

### LIST OF REFERENCE NUMERALS

With regard to the reference numerals used, the following numbering is used throughout the drawings.
101 Handle member
102 Head member
103 Aperture
104 Brush element
105 Interior gap
105X Interior gap distance
105Y Interior gap distance
105Z Interior gap distance
106 Adjustment lever
201 handle grip
201a Finger ridges
301 Removable head member
302 Lower protrusion member
303 Collar member
304 Electrical contacts
305 Electrical contacts
401 Power source
402 Power switch
403 Brush motor

### DETAILED DESCRIPTION OF THE INVENTION

Reference is made herein to the attached drawings. Like reference numerals are used throughout the drawings to depict like or similar elements of the pipe cleaning device. For the purposes of presenting a brief and clear description of the present invention, a preferred embodiment will be discussed as used for the pipe cleaning device. The figures are intended for representative purposes only and should not be considered to be limiting in any respect.

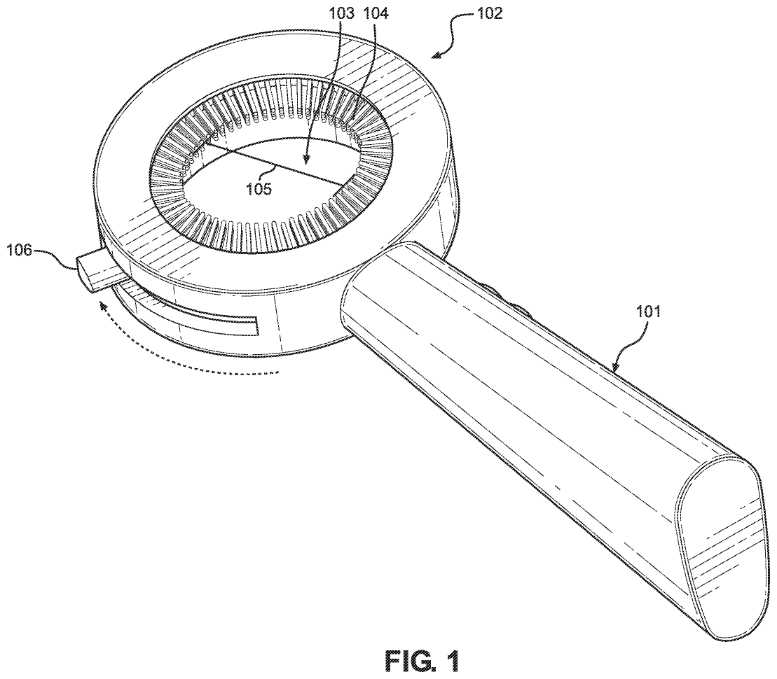

Referring now to FIG. 1, there is shown a perspective view of an embodiment of the pipe cleaning device. The pipe cleaning device is comprised of a handle member 101. The handle member 101 includes a base and at least one sidewall. The base and the at least one sidewall create an interior volume within the handle member 101. In one embodiment the handle member 101 is created from plastic. In another embodiment the handle member 101 is created from a suitable metal.

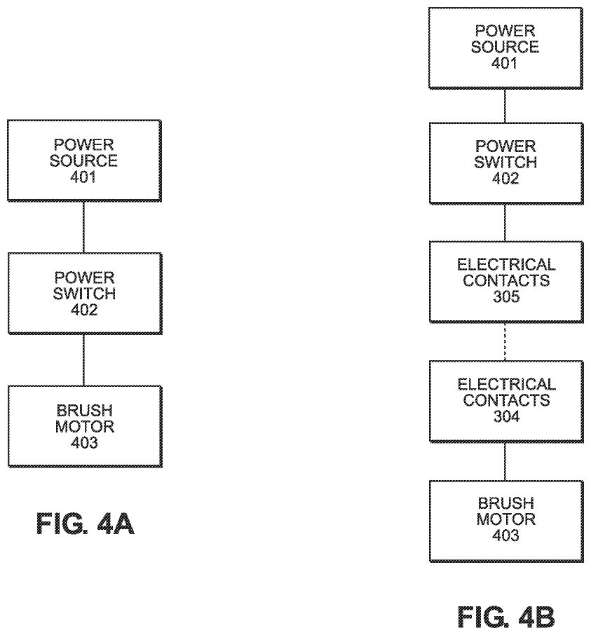

The pipe cleaning device is further comprised of a head member 102. The head member 102 is proportioned to fit around piping. In one embodiment the head member 102 is rounded. The head member 102 has an aperture 103 located through a middle thereof. The aperture 103 has at least one brush element 104 located around the interior perimeter of the aperture 103. In one embodiment there are four rows of brush elements 104. The at least one brush element 104 has an interior gap 105 that is configured to have a pipe placed therein. The brush element 104 is connected to a brush motor as described in the description of FIG. 4A and FIG. 4B. In one embodiment the at least one brush element 104 is made from aluminum. In another embodiment the at least one brush element 104 is made from steel.

In the shown embodiment the at least one brush element 104 is expandable and contractable. This means that the brush element 104 will have an interior gap 105 of changeable sizes. In one embodiment the at least one brush element 104 will expand to have a maximum two-inch diameter interior gap 105. In another embodiment the at least one brush element 104 will contract to a minimum one-half inch diameter interior gap 105. In alternate embodiments other maximum and minimum diameters are used.

In the shown embodiment the head member 102 has an adjustment lever 106 located on the exterior of the head member 102. The adjustment lever 106 will rotate the at least one brush element 104 expanding or contracting the interior gap 105.

In the shown embodiment the head member 102 is permanently affixed to the handle member 101. In other embodiments the interior gap 105 has a fixed diameter. In other embodiments as described below the head member 102 is removable. In one embodiment there will be different devices having different diameter interior gaps 105.

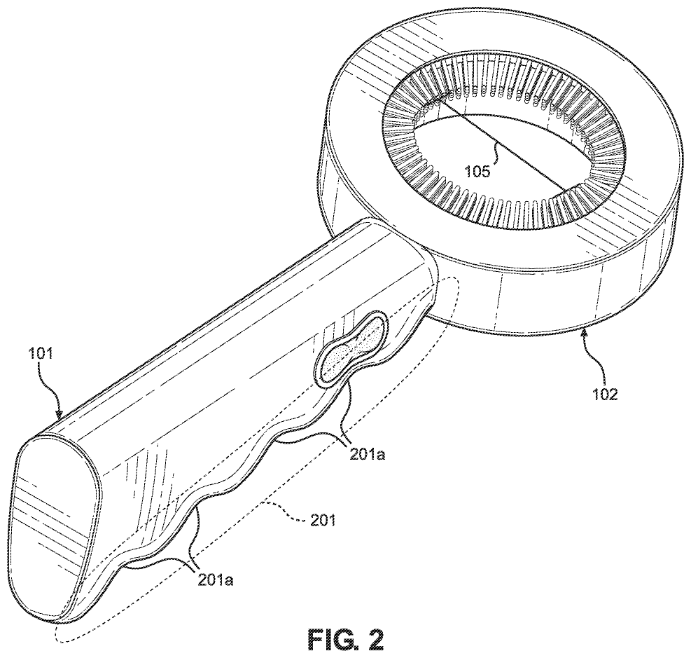

Referring now to FIG. 2, there is shown a perspective view of an alternative embodiment of the pipe cleaning device. The shown embodiment has a head member 102 that is fixed to the handle member 101. The at least one brush element has a fixed interior gap 105 diameter. In this embodiment to dean different sized pipes one will need to acquire different tools with different diameter interior gaps 105.

Further, in different embodiments the handle member 101 includes a handle grip 201. In one embodiment the handle grip 201 is made from a rubber material. In another embodiment the handle grip 201 is made from a plastic material. In one embodiment the handle grip 201 has an ergonomic grip feature. This will allow the handle grip to be comfortable for the user. In the shown embodiment the ergonomic grip feature includes finger ridges 201a.

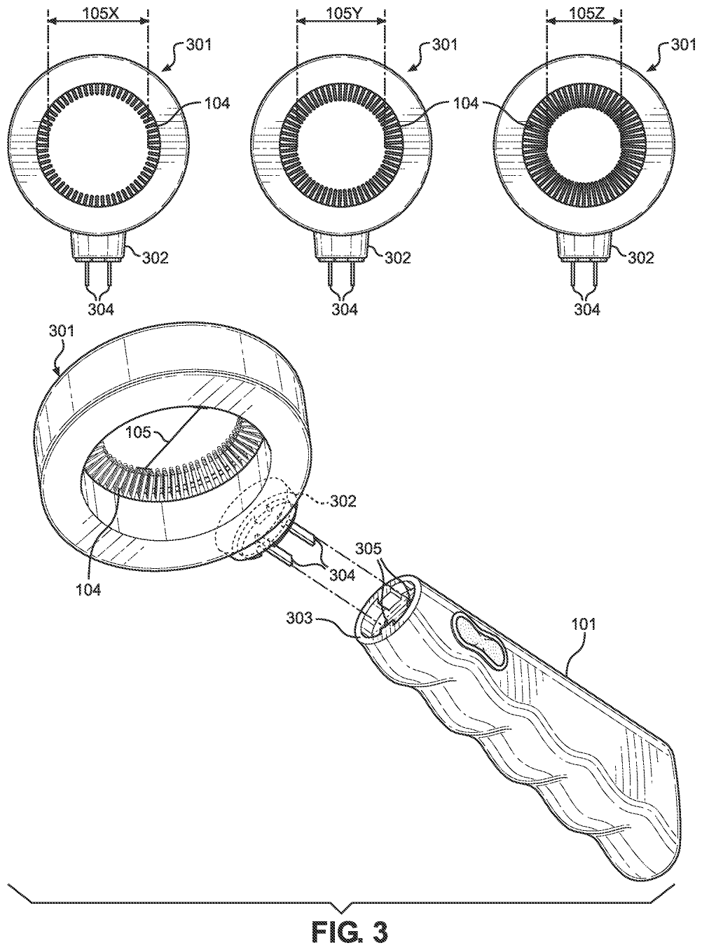

Referring now to FIG. 3, there is shown an exploded view of an alternative embodiment of the pipe cleaning device. In the shown embodiment the pipe cleaning device has a removable head member 301. The movable head member 301 is constructed identically to the fixed head members as described above. There removable head member 301 has at least one brush element 104 and an interior gap 105. In this embodiment the interior gap 105 has a fixed diameter. In other embodiments the interior gaps 105 may be changeable.

The removable head member 301 has a lower protrusion 302. The lower protrusion 302 is proportioned to fit within a collar member 303 of the handle member 101. The collar member 303 is attached to a top end of the handle member 101. The collar member 303 and the lower protrusion 302 will create a connection between the removable head member 301 and the handle member 101.

The lower protrusion member 302 further has electrical contacts 304 positioned thereon. The electrical contacts 304 will contact electrical contacts 305 located on the top end of the handle member 101. In one embodiment the electrical contacts 304 located on the lower protrusion member 302 are male contacts. The electrical contacts 305 on the top end of the handle member 101 are female contacts.

In the shown embodiment there are three different removable heads 301 shown. In one of the shown heads the interior gap 105z has a diameter of one-half inch. In one of the shown heads the interior gap 105y has a diameter of one inch. In one of the shown heads the interior gap 105x has a diameter of two inches. In the shown embodiment, the removable head members 301 will be able to be switched to meet the necessary pipe diameter requirements.

Referring now to FIG. 4A, there is shown a flow chart of an embodiment of the wiring for the pipe cleaning device. In this embodiment the head member is a fixed head. The pipe cleaning tool has a power source 401. In one embodiment the power source 401 is a battery. The power source 401 is located within the interior volume of the handle member. The power source 401 is connected to a power switch 402. The power switch 402 is located on the handle member and can be seen on the shown embodiments of FIG. 1, FIG. 2, and FIG. 3.

In this embodiment the power switch 402 is connected to a brush motor 403. The brush motor 403 will rotate the at least one brush member located within the head member. In one embodiment the brush motor 403 is a rotary motor. In one embodiment the power switch 402 and the brush motor 403 are configured to control the rotation speed of the at least one brush element. In one embodiment the power switch 402 is a variable depression speed control. In another embodiment the power switch 402 is a turn knob that can be set to different speed settings.

Referring now to FIG. 4B, there is shown flow chart of an embodiment of the wiring for the pipe cleaning device. This embodiment is for a pipe cleaning brush with a removable head member. In this embodiment there is a power source 401. The power source 401 is located within the handle member. The power source 401 is connected to a power switch 402. In several embodiments the power source 401 and power switch 402 operate as described above.

In this embodiment the power switch 402 is connected to electrical contacts 305 located within the handle member. When the removable head member is connected to the handle member, the electrical contacts 304 located on the removable head member will engage the electrical contacts 305 on the handle member creating a closed circuit. The electrical contacts 304 located on the removable head member are connected to the brush motor 403. This will rotate the at least one brush element when the power switch 402 is in an on position.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pipe cleaning device, the device comprising:
a handle member having and interior volume;
the handle member is attached to a head member;
the head member has an aperture located through a middle thereof, wherein the aperture is lined with a movable wire brush;
the head member further contains a brush motor, wherein the brush motor circulates the brush around the interior of the aperture.

2) The pipe cleaning device of claim 1, further comprising a power source located within the handle member.

3) The pipe cleaning device of claim 1, further comprising a switch located on the handle member, wherein the switch operably coupled to the brush motor.

4) The pipe cleaning device of claim 1, wherein the handle member has an ergonomic grip.

5) The pipe cleaning device of claim 1, further comprising multiple rows of wire brushes located within the aperture of the head member.

6) A pipe cleaning device, the device comprising:
a handle member having and interior volume;
the handle member is attached to a head member;
the head member has an aperture located through the middle thereof, wherein the aperture is lined with a movable wire brush;
the head member contains a movable lever, wherein the movable lever contracts and expands the wire brush;
the head member further contains a brush motor, wherein the brush motor circulates the brush around the interior of the aperture.

7) The pipe cleaning device of claim 6, further comprising a power source located within the handle member.

8) The pipe cleaning device of claim 6, further comprising a switch located on the handle member, wherein the switch operably couple to the brush motor.

9) The pipe cleaning device of claim 6, wherein the handle member has an ergonomic grip.

10) The pipe cleaning device of claim 6, wherein the brush expands to have a two-inch diameter.

11) The pipe cleaning device of claim 6, wherein the brush contracts to have a diameter of one-half inch.

12) The pipe cleaning device of claim 6, further comprising multiple rows of wire brushes located within the aperture of the head member.

13) A pipe cleaning device, the device comprising:
a handle member having and interior volume;
the handle member is removably attached to a removable head member;
the removable head member has an aperture located through the middle thereof wherein the aperture is lined with a movable wire brush;
the removable head member further contains a brush motor, wherein the brush motor circulates the brush around the interior of the aperture.

14) The pipe cleaning device of claim 13, further comprising a power source located within the handle member.

15) The pipe cleaning device of claim 13, further comprising a switch located on the handle member, wherein the switch operably couple to the brush motor.

16) The pipe cleaning device of claim 13, wherein the handle member has an ergonomic grip.

17) The pipe cleaning device of claim 13, further comprising electrical contacts located on a base of the removable head member.

18) The pipe cleaning device of claim 13, further comprising electrical contacts located on a top side of the handle member.

19) The pipe cleaning device of claim 13, further comprising a collar located about the top of the handle member, wherein the collar secures to the removable head member.

20) The pipe cleaning device of claim 13, further comprising multiple rows of wire brushes located within the aperture of the head member.
